(19) United States
(12) Patent Application Publication
(10) Pub. No.: US 2006/0223494 A1
(43) Pub. Date: Oct. 5, 2006

(54) Location-based emergency announcements

(76) Inventors: Mazen Chmaytelli, San Diego, CA (US); David Lee Larom, San Diego, CA (US); Christophe Bernard, San Diego, CA (US)

Correspondence Address: QUALCOMM INCORPORATED, 5775 MOREHOUSE DR., SAN DIEGO, CA, 92121, US

(21) Appl. No.: 11/096,693

(22) Filed: Mar. 31, 2005

(51) Int. Cl. H04M 11/04

(52) U.S. Cl. 455/404.2; 455/404.1

(57) ABSTRACT

A system and method for sending and receiving emergency announcements from a server to a client device are disclosed. The announcements can be sent based on the location of the client device and/or a designated time window. An announcement manager on the client device can display, store and manage the received announcements and activate additional applications based on the content of the emergency announcement.

### BACKGROUND OF THE INVENTION

1. Field

The present invention generally relates to communications between remote client devices and servers. More particularly, the invention relates to the creation, sending and viewing of emergency announcements across a wireless network to at least one client device.

2. Background

Advances in technology have resulted in smaller and more powerful personal computing devices. For example, there currently exist a variety of portable personal computing devices, including wireless computing devices, such as portable wireless telephones, personal digital assistants (PDAs) and paging devices that are each small, lightweight, and can be easily carried by users. More specifically, the portable wireless telephones, for example, further include cellular telephones that communicate voice and data packets over wireless networks. Further, many such cellular telephones are being manufactured with relatively large increases in computing capabilities, and as such, are becoming tantamount to small personal computers and hand-held PDAs. However, these smaller and more powerful personal computing devices are typically severely resource constrained. For example, the screen size, amount of available memory and file system space, amount of input and output capabilities and processing capability may each be limited by the small size of the device. Due to severe resource constraints, it is often typically desirable, for example, to maintain a limited size and quantity of software applications and other information residing on such remote personal computing devices (client devices).

Some of the personal computing devices utilize application programming interfaces (APIs), sometimes referred to as runtime environments and software platforms, that are installed onto their local computer platform and which are used, for example, to simplify operations of such devices, such as by providing generalized calls for device specific resources. Further, some such APIs are also known to provide software developers the ability to create software applications that are fully executable on such devices. In addition, some of such APIs are known to be operationally located between the computing device system software and the software applications such that the computing device computing functionality is made available to the software applications without requiring the software developer to have the specific computing device system source code. Further, some APIs are known to provide mechanisms for secure communications between such personal devices (i.e., clients) and remote devices (i.e., servers) using secure cryptographic information.

Examples of such APIs, some of which are discussed in more detail below, include versions of the Binary Runtime Environment for Wireless® (BREW®) developed by QUALCOMM, Inc., of San Diego, Calif. BREW® can cooperate with a computing device's (e.g., a wireless cellular phone) operating system, and can, among other features, provide interfaces to hardware features particularly found on personal computing devices. BREW® can also provide these interfaces on such personal computing devices at a relatively low cost with respect to demands on device resources and with respect to the price paid by consumers for devices containing the BREW® API. Additional features of BREW® include its end-to-end software distribution platform that provides a variety of benefits for wireless service operators, software developers and computing device consumers. At least one such currently available end-to-end software distribution platform includes logic distributed over a server-client architecture, where the server performs, for example, billing, security and application distribution functionality, and the client performs, for example, application execution, security and user interface functionality.

Enhancements to wireless client devices have included systems which enable emergency personnel to locate the client device when the emergency system is accessed. Accordingly, the ability to determine location has been integrated into many wireless client devices. For example, the wireless Enhanced 911 (E911) rules promulgated by the Federal Communications Commission (FCC) seek to improve the effectiveness and reliability of wireless 911 services by providing 911 dispatchers with additional information on wireless 911 calls.

The wireless E911 program is divided into two parts—Phase I and Phase II. Phase I requires carriers, upon appropriate request by a local Public Safety Answering Point (PSAP), to report the telephone number of a wireless 911 caller and the location of the antenna that received the call. Phase II requires wireless carriers to provide far more precise location information, within 50 to 100 meters in most cases.

The deployment of E911 has required upgrades to local 911 PSAPs, as well as coordination among public safety agencies, wireless carriers, technology vendors, equipment manufacturers, and local wireline carriers. The FCC established a four-year rollout schedule for Phase II, beginning Oct. 1, 2001 and to be completed by Dec. 31, 2005.

Accordingly, many client devices in service can already provide location information in accordance with the Phase II requirements. The present E911 system only provides location information upon the receipt of an emergency call. However, the present E911 system does not leverage the millions of users of wireless devices during emergencies.

The foregoing description of the related art is merely intended to provide an overview of some of the known uses of APIs and as an introduction to the BREW® platform, which can be used in embodiments of the invention. However, the invention is not to be construed as being limited to a specific implementation, operating platform or environment.

### SUMMARY OF THE EXEMPLARY EMBODIMENTS

Exemplary embodiments of the present invention are directed to a system and method for the creation, sending and viewing of emergency announcements across a network to a client device

At least one embodiment of the invention includes a wireless communication system for communicating emergency announcements comprising: a client device including, a transceiver; logic configured to receive an emergency announcement containing location data that defines a targeted geographic area operably coupled to the transceiver, and logic configured to display the emergency announcement on the client device, upon a determination that a geographic position of the client device is within the targeted geographic area.

Another embodiment of the invention includes a method for wirelessly communicating emergency announcements comprising: generating an emergency announcement containing location data; identifying a client device to receive the emergency announcement based on the location data in the emergency announcement and a location of the client device; transmitting the emergency announcement to the client device; receiving the emergency announcement at the client device; and displaying the emergency announcement on the client device upon a determination that the client device is within a targeted geographic area defined by the location data.

Another embodiment of the invention includes a wireless client device, comprising: a transceiver; a user interface; and a carrier announcement manager (CAM) configured to receive an emergency announcement containing location data, configured to determine if the client device is within a targeted geographic area defined by the location data contained in the emergency announcement, and configured to activate a notification device on the user interface upon receipt of the emergency announcement, if the client device is within the targeted geographic area.

Another embodiment of the invention includes a computer-readable medium on which is stored a computer program for wirelessly communicating location-based emergency announcements, the computer program comprising instructions which, upon being executed by at least one computing device, causes the computing device to perform the process of: receiving an emergency announcement containing location data that defines a geographic area; determining a geographic position of the client device; determining if the client device is within the geographic area defined by the location data in the emergency announcement; and displaying the emergency announcement on the client device upon a determination that the geographic position of the client device is within the geographic area.

Another embodiment of the invention includes a server for wirelessly communicating emergency announcements comprising: means for generating an emergency announcement containing location data that defines a geographic area; means for identifying a client device to receive the emergency announcement based on the geographic area and a geographic location of the client device; and means for transmitting the emergency announcement to the client device.

Another embodiment of the invention includes a client device for wirelessly receiving emergency announcements comprising: means for receiving an emergency announcement containing location data that defines a geographic area; and means for displaying the emergency announcement on the client device upon a determination that a geographic position of the client device is within the geographic area.

### BRIEF DESCRIPTION OF THE DRAWINGS

A more complete appreciation of embodiments of the invention and many of the attendant advantages thereof will be readily obtained as the same becomes better understood by reference to the following detailed description when considered in connection with the accompanying drawings which are presented solely for illustration and not limitation of the invention, and in which:

FIG. 1 is a diagram of a wireless network architecture that supports client devices and servers in accordance with at least one embodiment of the invention;

FIG. 2 is a more detailed diagram of a wireless network architecture that supports the client devices and servers in accordance with at least one embodiment of the invention;

FIG. 3 is a diagram representing the architecture of the CAM system in accordance with at least one embodiment of the invention;

FIG. 4 is an illustration of a announcement manager in accordance with at least one embodiment of the invention;

FIGS. 5A and 5B are diagrams of a wireless network architecture illustrating an announcement generating system, client device and location system in accordance with embodiments of the invention; and

FIGS. 6A-6C are flowcharts illustrating methods for transmitting and receiving emergency announcement in accordance with embodiments of the invention.

### DETAILED DESCRIPTION OF THE PREFERRED EMBODIMENTS

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

One or more embodiments of the invention can be used in conjunction with a runtime environment (e.g., API) executing on the computing device. One such runtime environment (API) is Binary Runtime Environment for Wireless® (BREW®) software previously discussed. However, one or more embodiments of the invention can be used with other types of runtime environments (APIs) that, for example, operate to control the execution of applications on wireless client computing devices.

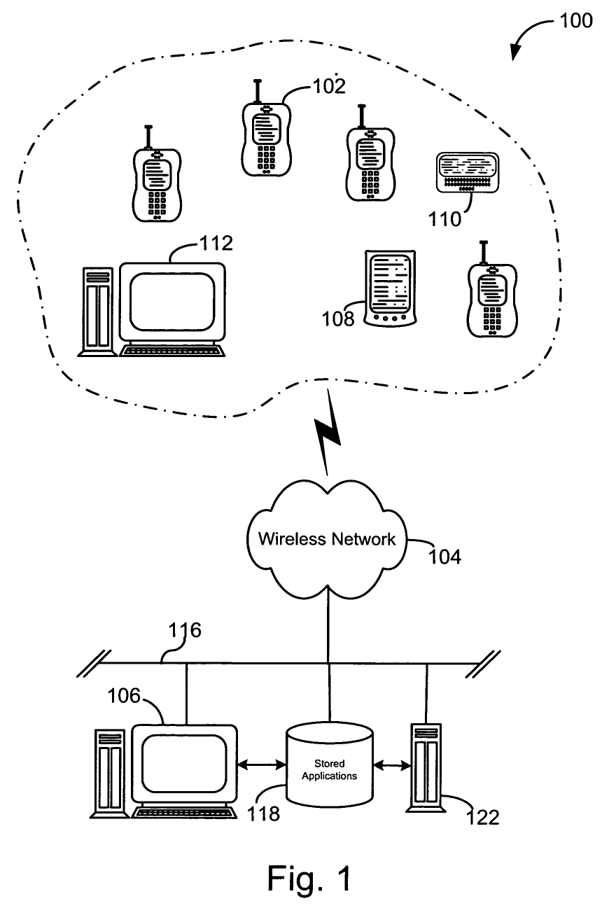

FIG. 1 illustrates a block diagram of one exemplary embodiment of a wireless system 100 in accordance with at least one embodiment of the invention. System 100 can contain client devices, such as cellular telephone 102, in communication across a wireless network 104 with at least one application download server 106 that selectively transmits software applications and components to wireless devices across a wireless communication portal or other data access to the wireless network 104. As shown here, the wireless (client) device can be a cellular telephone 102, a personal digital assistant 108, a pager 110, which is shown here as a two-way text pager, or even a separate computer platform 112 that has a wireless communication portal. The embodiments of the invention can thus be realized on any form of client device including a wireless communication portal, including without limitation, wireless modems, PCMCIA cards, personal computers, access terminals, telephones, or any combination or sub-combination thereof.

The application download server 106 is shown here on a network 116 with other computer elements in communication with the wireless network 104. There can be a stand-alone server 122, and each server can provide separate services and processes to the client devices 102, 108, 110, 112 across the wireless network 104. There is preferably also at least one stored application database 118 that holds the software applications that are downloadable by the wireless devices 102, 108, 110, 112. However, those skilled in the art will appreciate that the configuration illustrated in FIG. 1 is merely exemplary. Accordingly, embodiments of the invention can include one or more servers that can each perform all the described functions and contain all necessary hardware and software, or can contain only selected functionality.

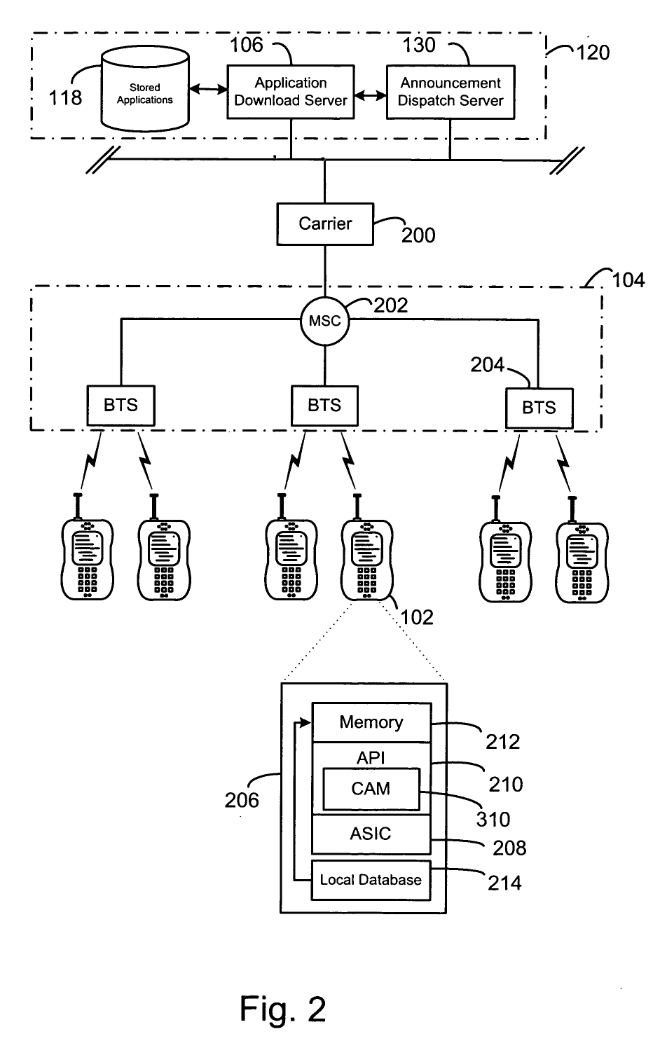

In FIG. 2, a block diagram is shown that more fully illustrates system 100, including the components of the wireless network 104 and interrelation of the elements of the exemplary embodiments of the invention. System 100 is merely exemplary and can include any system that allows remote client devices, such as wireless client computing devices 102, 108, 110, 112 to communicate over-the-air between and among each other and/or between and among components connected via a wireless network 104, including, without limitation, wireless network carriers and/or servers. The application download server 106 and the stored application database 118, along with any other servers such as announcement dispatch server 130 which are used to provide cellular telecommunication services, communicate with a carrier network 200, through a data link, such as the Internet, a secure LAN, WAN, or other network. In the embodiment shown, a server 120 can include the application download server 106, announcement dispatch server 130 and the stored application database 118. However, these servers can also be independent devices. The announcement dispatch server 130 can provide additional announcement services based on the configuration of each of the client devices 102, 108, 110, 112.

The carrier network 200 controls messages (typically sent as data packets) sent to a messaging service controller (“MSC”) 202. The carrier network 200 communicates with the MSC 202 by a network, the Internet and/or a public switched telephone network (PSTN). Typically, the network or Internet connection between the carrier network 200 and the MSC 202 transfers data, and the PSTN transfers voice information. The MSC 202 can be connected to multiple base stations (“BTS”) 204. In a similar manner to the carrier network, the MSC 202 is typically connected to the BTS 204 by a network, the Internet and/or PSTN for data transfer and/or voice information. The BTS 204 can broadcast data messages wirelessly to the client devices, such as cellular telephone 102, by short messaging service (“SMS”), or other over-the-air (OTA) methods known in the art. The terms API-directed, directed and BREW-directed SMS are used interchangeably in the following description to indicate an OTA message that includes coding to launch an application resident on the client device.

The client device, (here a wireless client computing device), such as cellular telephone 102, has a computer platform 206 that can receive and execute software applications and/or commands transmitted from the application download server 106, announcement dispatch server 130 and/or server 120. The computer platform 206 can include an application specific integrated circuit (“ASIC” 208), or other processor, microprocessor, logic circuit, or other data processing device. The ASIC 208 or other processor executes the application programming interface (“API”) 210 layer that interfaces with any resident programs in the memory 212 of the wireless device. The memory 212 can be comprised of read-only or random-access memory (RAM and ROM), EEPROM, flash cards, or any memory common to computer platforms. The API 210 also includes a Carrier Announcement Manager module (CAM) 310 containing logic configured to process special OTA (e.g., SMS) announcements transmitted from the carrier network 200. The computer platform 206 also includes a local database 214 that can hold applications not actively used in memory 212. The local database 214 is typically a flash memory cell, but can be any secondary storage device as known in the art, such as magnetic media, EEPROM, optical media, tape, soft or hard disk, and the like.

The wireless client computing device, such as cellular telephone 102, can have installed on it, or otherwise downloads, one or more software applications, such as games, news, stock monitors, and the like. For example, the cellular telephone 102 may receive one or more software applications downloaded from the application download server 106. The software applications may be stored on the local database 214 when not in use. The cellular telephone 102 or other wireless computing device may upload resident applications stored on the local database 214 to memory 212 for execution on the API 210 when so desired by the user or invoked by another API.

As used herein “client device”, “wireless device” or “client computing device” includes, for example, one or more processing circuits executing resident configured logic, where such computing devices include, for example, microprocessors, digital signal processors (DSPs), microcontrollers, portable wireless telephones, personal digital assistants (PDAs), and paging devices, or any suitable combination of hardware, software and/or firmware containing processors and logic configured to at least perform the operations described herein directed to emergency announcements communicated between a client device and a server. The client computing device can be serviced by at least one remote server with respect to at least such emergency announcements. Some examples of “wireless devices” which may be used in accordance with embodiments of the present invention include cellular telephones or other wireless communication units, PDAs, paging devices, navigation devices (e.g., GPS-based devices), handheld gaming devices, music or video content download units, and other like wireless communication devices.

The wireless communication between the client device 102 and the BTS 204 can be based on different technologies, such as code division multiple access (CDMA), time division multiple access (TDMA), frequency division multiple access (FDMA), the global system for mobile communications (GSM), or other protocols that may be used in a wireless communications network or a data communications network. The data communication is typically between the client device 102, BTS 204, and MSC 202. The MSC 202 can be connected to multiple data networks such as the carrier network 200, PSTN, the Internet, a virtual private network, and the like, thus allowing the client device access to a broader communication network. As discussed in the foregoing, in addition to voice transmission, data can be transmitted to the client device via SMS or other OTA methods known in the art. For convenience the term SMS will be used generally in the description. However, the invention is not limited to SMS messages, as noted above.

However, in addition to delivering basic messages, embodiments of the invention can utilize APIs to access the enhanced functionality of the client devices. Further, these API-directed SMS messages that allow access to underlying APIs can be separated from the conventional SMS messages and stored in a separate inbox to allow for the easy organization, storage, and retrieval of the relevant enhanced SMS messages. Accordingly, one aspect of embodiments of the invention includes a specialized API for managing these enhanced SMS messages, hereinafter referred to as a Carrier Announcement Manager (CAM).

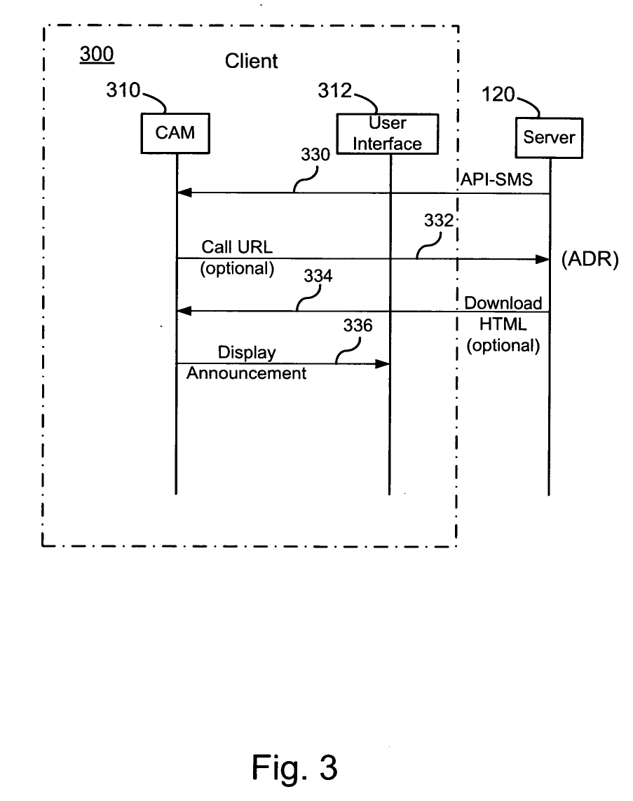

In FIG. 3, an example of the system interaction with the Carrier Announcement Manager (CAM) architecture is illustrated. CAM 310 can be installed into a client device 300. In at least one embodiment of the invention, server 120 (e.g., residing on a carrier network) can act as the Short Message Service Center (SMSC) and announcement dispatch server. However, the SMSC and announcement dispatch server can also reside on independent devices and/or networks that are operably coupled to the carrier network. Server 120 can send the emergency announcements to the CAM 310 using a variety of techniques. For example, server 120 can send an API-directed SMS message 330 that contains data to be inserted into predefined HTML templates that are already resident on the client device 300. The announcement can then appear on the user interface/display 312 of the client device without any action from the end-user. Accordingly, the CAM 310 can display 336 the announcement on client device 300 in an attractive and informative announcement, using only the limited data sent in the SMS message. The SMS message can be text, a URL or both. For example, the SMS message 330 can contain text and an associated URL that allows a user of the client device 300 to connect to a specific site for additional information.

In another example, the server 120 can send an API-directed SMS message 330 containing a URL to perform a call back to server 120 (announcement dispatch server 130 or other remote server). For example, CAM 310 can receive the message and call an appropriate API (e.g., a browser) to initiate the connection 332 to the server 120 and download an associated HTML page (e.g., a map showing a traffic accident) 334 to client device 300. After the HTML page has been downloaded, the page can be displayed on display 312 on the client device 300. In this embodiment, the HTML callback allows server-stored graphic announcements to be placed on the main screen of the client device 300 instead of a simple SMS text-only announcement. This format of API-directed SMS message can be referred to as an Announcement Download Request (ADR). Unlike the pure SMS methods, the ADR does not contain the display data itself. Instead its payload is a URL pointing to an announcement located on the server 120 or other remote server. CAM 310 downloads the announcement from the URL given by the ADR and can present it according to a predefined rule set. Separate HTML announcements can be cached on the server 120 for each client device type (e.g., specific handsets, PDAs, runtime environments, and the like), or the server 120 can have an application that builds an HTML announcement on the fly, tailoring the announcement to the capabilities of the client device 300.

To allow for greater flexibility, carriers can choose between direct API-directed SMS announcements, which minimize download times, network load and storage space, or HTML callback announcements, which can be of higher quality with richer environments, but can also have greater download times and increase network load.

The CAM inbox can be used to store and present the announcements as a series of scrolling one-line headlines. The announcement itself can define an intelligible headline. For example, the default headline can be the initial characters of the SMS payload. The end-user can use the up/down arrow keys on typical client devices or other navigational keys to go between announcements. Two softkeys (e.g., “Exit” and “Manage”) can be presented at the initial access of the CAM inbox that allows the user to exit the CAM inbox or manage the announcement. For example if manage is selected, two softkeys can be presented for a selected headline, such as “Open” and “Delete.” The headline can also be presented on the external screen of “clamshell”-style phones. However, these examples are provided for purposes of illustration only and the invention is not limited to a specific menu structure, label, or functional relationship. Those skilled in the art will appreciate that many alternative menu structures, key combinations, and labels can be used.

To enhance the possibility that the announcement will be viewed and acted upon, in one embodiment the announcement cannot be deleted at the initial presentation/notification and can only be sent to the CAM inbox. The announcement can be deleted from the CAM inbox screen or in the normal maintenance of the CAM inbox. Additionally, the announcements can be locked either by the user or by the announcement sender to prevent the deletion of important emergency messages, until the announcements are unlocked. To further enhance the possibility that the end-user views the emergency announcement, upon reception of the emergency announcement the CAM can activate ringers, buzzers, vibrators, lights, or other notification devices on the client device.

In at least one embodiment of the present invention, the CAM can be pre-installed on a client device, such as a wireless phone enabled with QUALCOMM's BREW® (Binary Runtime Environment for Wireless). However, other APIs and devices can be used and the invention is not limited to a specific platform or device. Additionally, the CAM system can be optionally pushed to the client device via a carrier or the end-user can voluntarily download the CAM system. Once the CAM system is installed, the device pan receive and present announcements to the end-user as described herein.

Although the invention is not limited to a specific device, knowing the type device that the CAM is installed on aids in the effective presentation of the announcements. For example, the device specific features such as the screen size, input devices, memory, resident APIs and the like, dictate how much information can be displayed and how rich the content of the information can be. Typically, larger screen devices can allow for much richer announcements, optionally containing images or other graphics. Based on the particular application, the minimum device screen size, for example, can be chosen as the basis for the message type.

An emergency announcement can be sent to the client device using various push mechanisms that enable the device to receive messages. In one exemplary embodiment of the present invention, an API-directed SMS can be used as the push mechanism. For example, a BREW-directed SMS can include the class ID of a BREW application and the data that the application will be able to retrieve when it receives the SMS. The data sent in the SMS can contain the text to be displayed on the announcement page and the ID of the application, which will be used, for example, to bring the end-user to a page where emergency information can be accessed.

In another exemplary embodiment of the invention, a network connection to a server can be used as the push mechanism. The CAM application in this embodiment can connect to the server automatically on a periodic basis (e.g., every five minutes) or when manually activated to check if there is a new announcement. This embodiment can allow the direct download of richer announcements that can incorporate graphics, text, hyperlinks, multimedia and the like, when an announcement is available.

In another exemplary embodiment of the invention, a combination of both API-directed SMS and a network connection can be used as the push mechanism. The SMS trigger (e.g., a directed SMS message that activates the CAM and contains a URL pointed to the desired remote server location) tells the application to wake up and connect to a server. The application would then connect to a server and retrieve the detailed announcement data, such as text, pictures and application ID.

For example, a typical format to call an application on a BREW® enabled device is //BREW:<APP ID>:<Payload>. The App ID is a unique number that identifies the BREW® application. Payload is the data for the called application. Accordingly, at least one embodiment of the present invention can include a CAM specific call (App ID) and payload. For example, a system notification to users of a CAM enabled device of an Amber Alert can include a format such as “//BREW:<CAM ID>[X][Y][R][Popup Text][Secure URL]”, where “[” and “]” are separators, X and Y define center of a circle of interest, R is the radius of the circle of interest, Popup Text is the message shown to the user, (e.g. “New Amber Alert. Click YES to view details”) and Secure URL is a secure URL (e.g., “https://amber.carrier.com/2004/12/09/xyz”) to which the client device can connect to for retrieving information regarding the Amber Alert (e.g., pictures of the kidnapping victim, description of suspect automobile, license plate, etc.). Accordingly, an example emergency announcement can be provided in the following format: //BREW:01009FFO[134][456][789][“New Amber Alert. Click YES to view”][https://amber.carrier.com/2004/12/09/xyz]. Those skilled in the art will appreciate that other configurations of the emergency announcement can be used and a variety of different data types can be used to define the geographic area of interest. For example, the payload can contain date/time information to indicate an expiration date/time of the emergency announcement, an announcement ID so that delivery of the announcement can be tracked, and additional coding to activate features of the CAM system discussed herein. Further, the location information can be any type of information that defines a targeted area and is not limited to latitude and longitude coordinates.

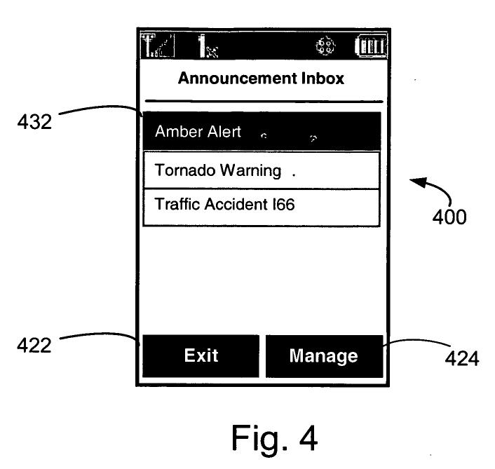

FIG. 4 is an exemplary diagram of the CAM inbox 400. The CAM system can send an announcement into an inbox, similar to an SMS inbox. FIG. 4 illustrates an example of a menu of choices (e.g., 432) that can appear in an inbox interface. The end-user can then click on one of the menu options to display the selected announcement. For example, in FIG. 4, the user could click on “Amber Alert” 432 to see the announcement relating to that menu item. Additionally, softkeys 422 and 424 are provided for exiting and access to management of the CAM inbox menu, respectively. However, the invention is not limited to the specific configuration and softkey functions discussed. Other softkey functions (e.g., lock, delete, and the like) and menu layouts can be easily configured as will be appreciated by those skilled in the art.

In another exemplary embodiment of the present invention, the foregoing features of the CAM system can be leveraged to provide time and location-based emergency announcements. For example, the CAM system can be used to send emergency messages to end-users based upon location of the end-user and/or time of the event. Accordingly, the location of the client device can be used to determine which client devices receive or will display the emergency announcement. Using the location-based announcement feature can minimize network traffic, and deliver the announcements to the most relevant audience, which can increase the effectiveness of the emergency announcements.

Position location capabilities have been increasingly incorporated into wireless client devices, such as the E911 features previously discussed. Additionally, the accuracy of the position location features has been increased with each new generation of device. A variety of systems are known for providing wireless position location information, such as network-based location information, client-based location information and hybrid location information. Network-based solutions rely on the signal transmitted from the client device and received at multiple fixed base stations, using Angle of Arrival (AOA) and Time of Arrival (TOA) to determine position. Client-based solutions make use of the Global Positioning System (GPS), a worldwide system of twenty-four satellites and their ground stations. By accurately measuring the distance from four or more satellites, the receiver can obtain its position anywhere on earth. Hybrid solutions, such as QUALCOMM's gpsOne® provide a combination of network-based and GPS solutions. For example, in rural and suburban areas, not many base stations can receive signals from the handset, but a GPS receiver can often receive data from four or more satellites. Conversely, in dense urban areas and inside buildings, GPS receivers may not detect enough satellites, but the wireless handset can contact two or more base stations.

Regardless of the technology used for determining the location of the wireless client device, the location information can be accessed, typically by APIs designed to access the location position data. Accordingly, an API-directed SMS announcement can initiate a location API (or other location application) in the client device to determine the client device location. Alternatively, the client device location can be determined from data previously stored at the server.

The announcement sender can be a carrier or trusted partner (e.g., police, FEMA, public safety official, PSAP, government entities, designated private entities, and the like) with network access. The sender can determine the target audience based upon the location of the client device and/or the time of the event. For example, the sender can specify latitude and longitude and a radius for desired audience. Accordingly, all active client devices that are within the location range specified by the sender can receive the announcement. For example, all active clients within a five mile radius of a kidnapping could receive an announcement describing information that could aid in capturing the kidnapper (e.g., description of the victim, license number, and the like). As a further refinement, the emergency announcement can be both limited by location and sent only in a specific time window (e.g., to a specific county during a severe weather event). Alternatively, the location can be identified by a specific landmark and/or immediate adjacent areas. For example, the National Mall in Washington D.C. could be designated and all client devices in the National Mall area could receive an emergency announcement.

Additionally, to further enhance the functionality of the announcements, the announcements can be location and time sensitive after they have been received and stored in the CAM inbox. For example, the announcements can be automatically deleted from the CAM inbox when the client device is no longer within the specified location parameters (e.g., the end-user is past an accident area). Further, the announcement can also be automatically deleted based on temporal conditions. For example, the announcement can be automatically deleted at a predetermined time (e.g., the severe weather warning ends at midnight). The automatic deletion of non-relevant announcements can reduce the maintenance of the CAM inbox and can help to ensure that only relevant emergency announcements are stored therein.

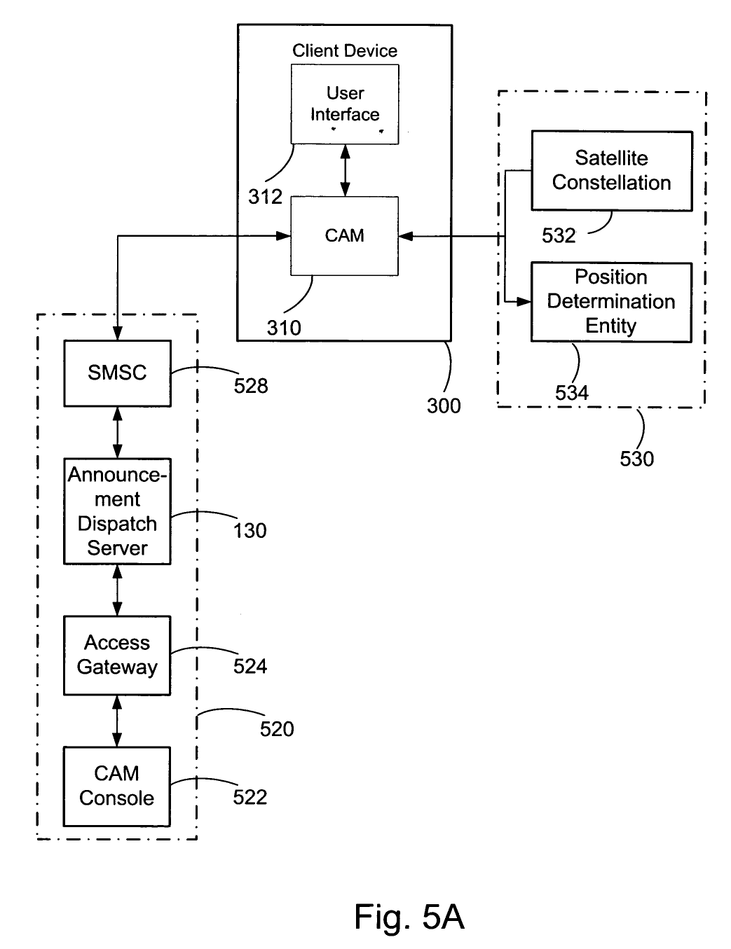

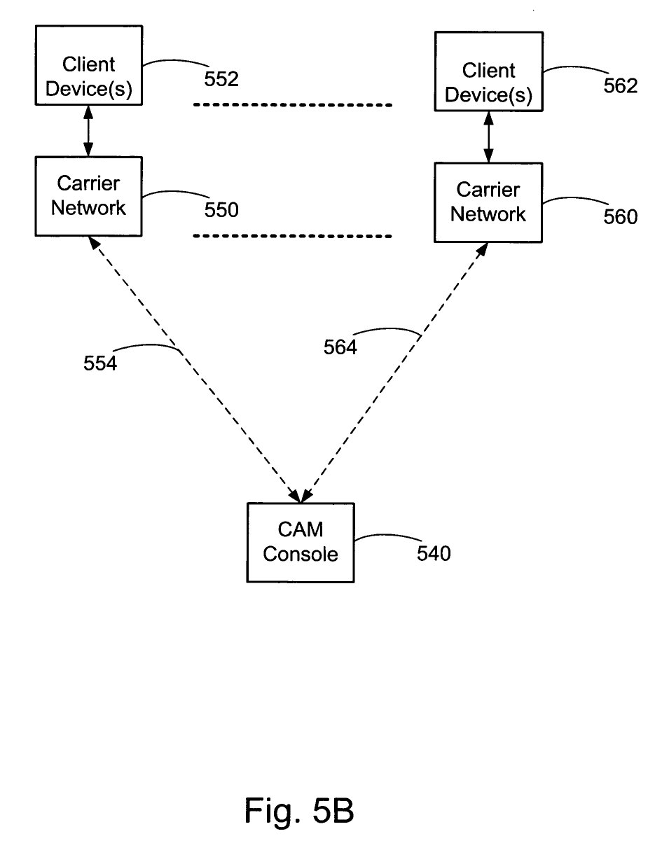

FIG. 5A is a block diagram of a system that can be used by a sender to deliver the emergency announcements, according to at least one embodiment of the invention. A client device 300 can include a user interface 312 (e.g., keypad, buttons, speaker, indicator light, display, and the like) operably coupled to a CAM system 310, as previously discussed. An announcement generation system 520 can include a CAM console 522 that allows a sender to access the system 520 and generate the announcements including the location-based data (e.g., specific longitude, latitude and radius). The CAM console can be either at the carrier network or at a remote trusted sender (e.g., a 911 call center, local police, FBI, FEMA, and the like). Optionally, an access gateway 524 can be coupled between the CAM console 522 and the announcement dispatch server 130. The access gateway 524 can be configured to provide secure communications between the CAM console 522 and the announcement dispatch server 130, using encryption and/or other techniques known in the art. Further, the CAM console can be coupled to the access gateway via the Internet, VPN, PSTN, wireless link, and the like.

Alternatively, if the CAM console 522 is located at the carrier network, the announcement generation system 520 can be integrated into one computer-based system which can include the CAM console and announcement dispatch server functionality. Further, a Short Message Service Center (SMSC) 528 can be part of the announcement generation system 520 and used to send directed-SMS messages to the client device 300. However, other OTA data transmitting techniques can be used and SMSC 528 is not required in all embodiments of the invention.

Referring to FIG. 5B, an alternative embodiment of the invention is illustrated in which a CAM console 540 is operably coupled to at least one additional announcement dispatch server. Further, as illustrated each announcement dispatch server (not illustrated) are coupled to or contained within two different carrier networks 550, 560. The configuration of FIG. 5B, allows for one common CAM console to access different carrier networks 550, 560 and ultimately the different client devices 552, 562 in communication with each network. This feature can allow a central CAM console 540 to access multiple client devices (e.g., 552, 562) residing on multiple carrier networks (e.g., 550, 560) which simplifies the dissemination of the emergency announcement to multiple carriers and can increase the delivery to the desired client devices. For example, during an Amber Alert, client devices 552 in communication with a first carrier 550 and client devices 562 in communication with a second carrier 560 may be within the targeted area. Accordingly, generating an appropriate Amber alert emergency announcement at CAM console 540 and sending it to the first carrier network 550 and the second carrier network 560 can greatly increase the number of client devices that receive the emergency announcement. The carrier networks 550, 560 can be connected to CAM console 540 by a secure links 554, 564, to limit the potential for unauthorized access to the announcement dispatch servers and client devices. Accordingly, links 554, 564 can be connections via the Internet, virtual private network (VPN), public switched telephone network (PSTN), and/or a wireless link using secure transmission capabilities as is known in the art. Likewise, those skilled in the art will appreciate that more than one CAM console (e.g., a police CAM console, a traffic CAM console, and the like) can be connected to the carrier network.

The client device location can be determined, for example, based on data contained at the client device, data contained at the carrier and/or location data communicated to the carrier or other remote server. For example, in FIG. 5A, an external location system 530 can be accessed by the client device 300. Specifically, CAM 310 can acquire position data from visible GPS satellites 532, once received the position data can be relayed to a position determination entity (PDE), e.g., a server in the carrier network. The PDE 534 can then analyze the position data and determine the location of the client device 300. The location (e.g., longitude and latitude and optionally altitude coordinates) of the client device 300 can then be stored at a remote server and/or communicated to the client device 300, for storage and/or use by CAM 310. For example, CAM 310 can use the longitude and latitude and optionally altitude coordinates to determine if the client device 300 is within the designated geographic area defined by the location data in the emergency announcement.

Alternatively, the device location can be determined at the client device 300 and external servers do not need to know the specific location of the client device, which may provide more privacy for the end-user. For example, the location of the client device 300 can be determined from visible GPS satellites 532 directly, using known techniques. In this embodiment, there is no need to transmit location data or related information to a remote server for further processing. Accordingly, the location information associated with the emergency announcement can be used by the client device to determine whether the client device is within the targeted geographic area defined by the location information transmitted in the emergency announcement. If the client device determines that it is not within the targeted area, the emergency announcement can be discarded, without interrupting the end-user.

Alternatively, in another embodiment of the invention, an emergency announcement contains location information that can be used to define a geographic area. Client devices within the targeted area (i.e., the defined geographic area) can be identified from the location information stored on a server in the carrier network. For example, a CAM enabled client device can periodically report the location of the client device or execute an application to provide location data to a remote server that can calculate the location of the client device. The stored location information can be a table, for example, containing longitude and latitude coordinates for each client device. When an emergency announcement is generated containing location information to define a geographic area of interest (e.g., longitude and latitude coordinates of four points defining a rectangular area), a server can use the stored client location information to identify the client devices in the area of interest. Then the emergency announcement can be sent to the client devices that are identified. Although the emergency announcement location information does not have to be transmitted to the client device in this embodiment, the location information can still be used by the CAM system on the client device for inbox maintenance (e.g., to delete messages that are out of the defined area) as discussed above. Alternatively, if the client device location is monitored at a remote server, then the announcement generation system can generate another message that directs the CAM system on the client device to delete a specific announcement based on the client device location. Additionally, a message that directs the CAM system on the client device to delete a specific announcement can be event-based, such as deleting an Amber Alert emergency announcement once the victim is located. Accordingly, this aspect can be used regardless of whether the client device location data is maintained locally or remotely.

The process of identifying the client device location can include many variations and sub-processes. For example, the device location can be determined by accessing client device location information. Then, the client device location can be used to determine if the client device is within a geographic area defined by the location data in the announcement. The location information can be stored locally at the client device and/or remotely (e.g., at a server on the carrier network). Likewise, the determination as to whether the client device is within the geographic area and can be determined at either the client device or a remote server. The client device location information can include longitude and latitude coordinates of the client device. Likewise, the location data in the announcement can include center longitude and center latitude coordinates and a radial distance. The geographic area can then be determined as longitude and latitude coordinates that are within the radial distance from the center longitude and the center latitude coordinates. Alternatively, the location data in the announcement can include at least three longitude and latitude coordinates, which define an area (e.g., triangle, square, and rectangle). The geographic area can then be determined as longitude and latitude coordinates that are within the area defined by the at least three longitude and latitude coordinates.

Further, depending on the accuracy desired, base stations and/or communication towers can be used to determine the targeted client devices. In this embodiment, the location data generated in the emergency announcement can be used to define a geographic area as discussed above. Then, client devices communicating with base stations/communication towers within the defined geographic area can be considered to be within the targeted geographic area and can be sent the emergency announcements. However, this aspect can be used in combination with the previously discussed methods for delivering location-based emergency announcements.

For example, instead of transmitting the emergency announcements directly, a “wake-up” message can be sent to the client devices that invoke the CAM system on each client device, which reports the location of the client device. The updated location information can be used by the server to then target only those devices that are actually within the targeted geographic area. Alternatively, client devices communicating with the identified base stations/communication towers can be sent the emergency announcement and the CAM system on the client device can use the local geographic location data or obtain a geographic location. Using its geographic location and the geographic area defined in the emergency announcement, the client device can determine if it is within the targeted area, as discussed above. Using the base station/communication tower as a first level of granularity to identify a client device can further reduce the network traffic and focus the announcements to client devices that are most likely within the targeted geographic area.

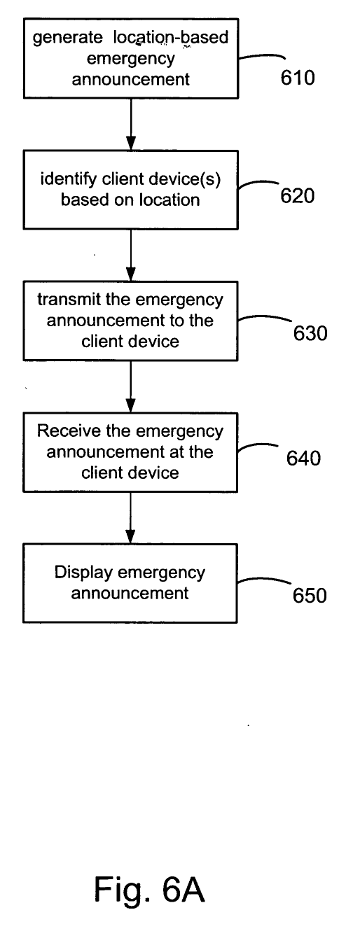

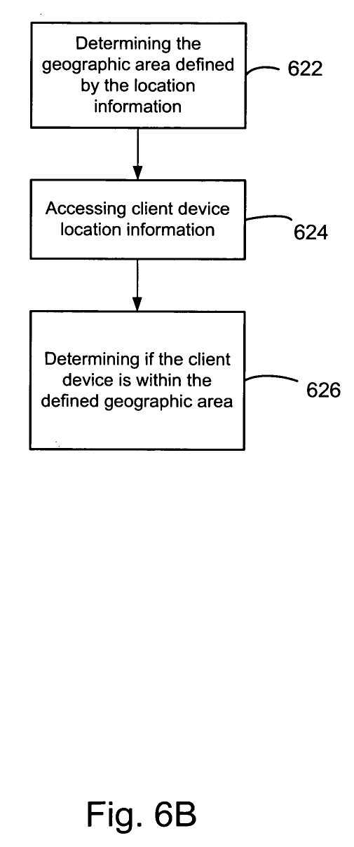

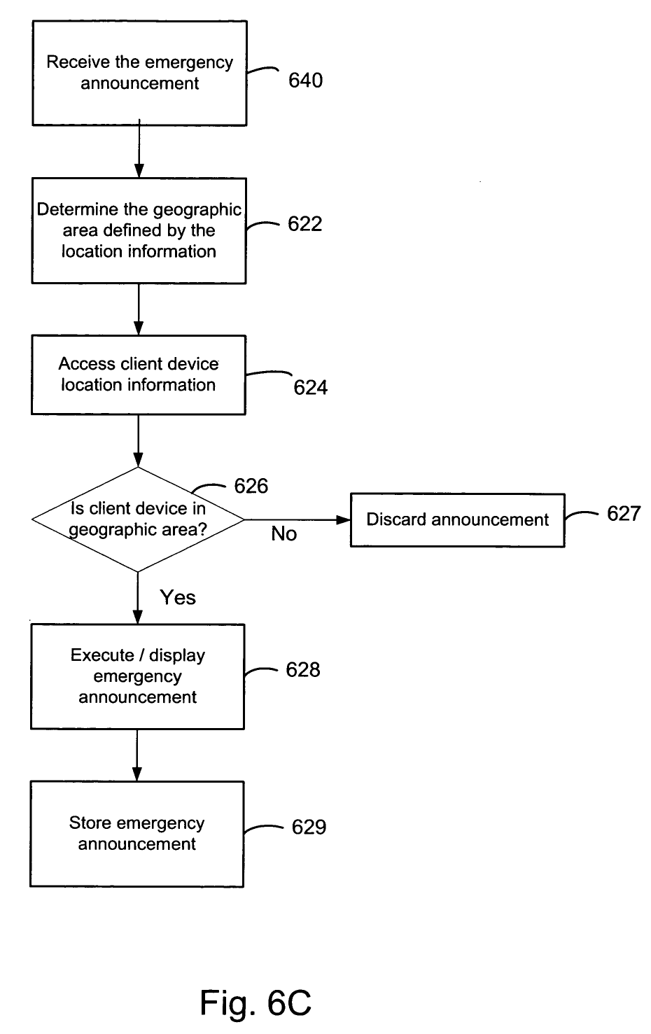

In view of the foregoing disclosure, those skilled in the art will recognize that embodiments of the invention include methods of performing the sequence of actions, operations and/or functions previously discussed. For example, as illustrated in FIG. 6A, a method for wirelessly communicating emergency announcements can include generating an emergency announcement containing location data, at block 610. A client device to receive the emergency announcement is identified based on the location data in the announcement and the location of the client device, in block 620. Further, the emergency announcement can be transmitted to the client device, in block 630. The emergency announcement can be received at the client device, block 640, and the emergency announcement can be displayed on the client device, block 650. Those skilled in the art will appreciate that the flowchart illustrated is not limited to sequential execution and block elements may be reordered as desired. For example, block 620 can be inserted between block 640 and block 650 to represent the relevant operations when the client device determines whether or not it is within the geographic area defined in the emergency announcement.

FIG. 6B is a flowchart illustrating a method for identifying client devices based on the geographic area defined by the location data in the emergency announcement. In block 622, the targeted geographic area is determined using the location data contained in the emergency announcement. As discussed above, this determination can be performed at the client device, a server on the carrier network, and/or other remote server. The client device location information is accessed, in block 624. Once again this can be performed at the client device, a server on the carrier network, and/or other remote server, as previously discussed. Further, accessing the data can include any of the methods discussed herein (e.g., accessing previously stored geographic position data in the client device or on a server remote to the client device, initiating a location API resident on the client device to obtain the location of the client device (e.g., using gpsOne®), and the like). Then, in block 626, the geographic position of the client device can be compared with the targeted area to determine if the client device is within the targeted area. Likewise, this determination can be performed at the client device, a server on the carrier network, and/or other remote server, as previously discussed.

For example, FIG. 6C illustrates an embodiment of the invention where the client device determines if it is in the targeted geographic area. In this configuration, as discussed above, the sequence of actions are different than illustrated in FIG. 6A, in that the announcement is received at the client device (e.g., 640) before the client device is identified (e.g., 620) as being in the targeted geographic area. Alternatively, the client device can be identified at a first level, such as by base station/communication tower, city, region, or other generally broad geographic zones, in block 620. Then, the process illustrated in FIG. 6C, can be a further refinement performed at the client level after the emergency announcement has been received.

In describing FIG. 6C, like functions will retain the same reference number. Accordingly, blocks 622, 624 and 626 operate as discussed above; however, at the client device. If the client device receives an emergency announcement, but it is not in the targeted geographic area, the announcement is discarded, block 627. If the client device is in the targeted geographic area than the announcement is displayed or the associated instruction is executed (e.g., start browser and download specified page), block 628. The term display can include any type of notification, such as a text and/or graphic display on a display unit, indicator lights, audible signal (e.g., buzzer, ringer, voice message, and the like), vibration, and combinations of the foregoing. The message can be stored for recall at a later time, in block 629. Once stored the emergency announcement can be recalled automatically on a periodic basis, or at a user's request. Further, the announcement can be stored in a designated inbox for management by the user and/or automatic inbox management by the CAM, as previously discussed.

As can be appreciated from the foregoing, embodiments of the present invention can leverage the client device location information and CAM features to enhance emergency services by providing valuable emergency information to the end-users and senders (e.g., police, government agencies and the like). For example, as illustrated in FIG. 5A, a sender (e.g., an operator or government entity) can log into CAM console 522 and connect to an announcement dispatch server 130 coupled to the carrier network. The sender may then generate an announcement push regarding an emergency (e.g., an abduction or “Amber Alert”) by sending information such as last known location or appearance and a search radius (e.g., two miles). The IDs of the subscribers to receive the emergency announcement can be determined as discussed above. The announcement dispatch server 130 and/or SMSC 528 can send the emergency announcement (e.g., a BREW® directed SMS) to, for example, all client devices within the defined radius of where the abduction occurred. The emergency announcement (e.g., BREW® directed SMS) can activate the CAM 310 on the client device 300 (e.g., BREW® enabled phone). CAM 310 can obtain the position of the client device 300 via GPS, utilizing satellite constellation 532 and/or Position Determination Entity 534, and determine if the client device 300 is within the targeted area (e.g., as defined by the kidnapping location and radius). If the client device 300 is within the targeted area, CAM 310 can display a message along with a voice prompt indicating that a kidnapping has occurred and other relevant information relayed in the emergency announcement. Additionally, the user interface 312 can contain a message, such as “If you have relevant information, press OK to report it to the police.” If the user has relevant information, they can press, “OK”, which allows the CAM 310 to send the user's location to the police server, enabling police officers to travel to that location. Additionally, a direct voice link can be established to the operator, 911 call center or government entity or callback information can be relayed so that the user can be contacted to verify that they have relevant information. Accordingly, embodiments of the present invention can include direct feedback mechanisms to further enhance the effectiveness of the emergency announcements. For example, the feedback mechanism can be one of a touch screen, a softkey, a hardkey, a hyperlink, a menu selection and the like.

In further embodiments, those skilled in the art will appreciate that the foregoing methods can be implemented by the execution of a program embodied on a computer readable medium, such as the memory of a computer platform. The instructions can reside in various types of signal-bearing or data storage primary, secondary, or tertiary media. The media may comprise, for example, RAM accessible by, or residing within, the client device and/or server. Whether contained in RAM, a diskette, or other secondary storage media, the instructions may be stored on a variety of machine-readable data storage media, such as DASD storage (e.g., a conventional “hard drive” or a RAID array), magnetic tape, electronic read-only memory (e.g., ROM, or EEPROM), flash memory cards, an optical storage device (e.g. CD-ROM, WORM, DVD, digital optical tape), paper “punch” cards, or other suitable data storage media including digital and analog transmission media.

While the foregoing disclosure shows illustrative embodiments of the invention, it should be noted that various changes and modifications could be made herein without departing from the scope of the invention as defined by the appended claims. The activities or steps of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A wireless communication system for communicating emergency announcements comprising:
a client device comprising:
a transceiver;
logic configured to receive an emergency announcement containing location data that defines a targeted geographic area operably coupled to the transceiver; and
logic configured to display the emergency announcement on the client device, upon a determination that a geographic position of the client device is within the targeted geographic area.

2. The system of claim 1, further comprising:
logic configured to determine if the client device is within the targeted geographic area;
logic configured to generate the emergency announcement; and
logic configured to transmit the emergency announcement to the client device.

3. The system of claim 2, wherein the logic configured to determine if the client device is within the targeted geographic is located in at least one of the client device, a remote server operably coupled to a carrier network, and a server in the carrier network in communication with the client device.

4. The system of claim 1, wherein the geographic position of the client device is determined using at least one of network-based location information, client-based location information and hybrid location information.

5. The system of claim 1, wherein the emergency announcement contains code configured to initiate an application resident on the client device.

6. The system of claim 5, wherein the emergency announcement contains data that is used by the application resident on the client device.

7. The system of claim 6, wherein the emergency announcement initiates a browser application and the data is a uniform resource locator (URL) that directs the browser to a specified site.

8. The system of claim 1, wherein the client device is at least one of a wireless computing device, a wireless telephone, a cellular telephone, a personal digital assistant (PDA), and a paging device.

9. The system of claim 1, wherein the emergency announcement is at least one of a Short Message Service (SMS) message and a hypertext markup language (HTML) document.

10. The system of claim 1, wherein the client device further comprises logic configured to store the emergency announcement including the location data.

11. The system of claim 10, wherein the emergency announcement is automatically deleted from the client device based upon at least one of a current location of the client device, a specified time and an event-based trigger.

12. The system of claim 11, wherein the client device further comprises logic configured to activate a notification device on the client device upon receipt of the emergency announcement.

13. The system of claim 12, wherein the notification device comprises at least one of displayed text, an icon on a display, an indicator light, an audible signal, and a vibration.

14. A method for wirelessly communicating emergency announcements comprising:
generating an emergency announcement containing location data;
identifying a client device to receive the emergency announcement based on the location data in the emergency announcement and a location of the client device;
transmitting the emergency announcement to the client device;
receiving the emergency announcement at the client device; and
displaying the emergency announcement on the client device upon a determination that the client device is within a targeted geographic area defined by the location data.

15. The method of claim 14, wherein the emergency announcement comprises a Short Message Service (SMS) message containing code configured to initiate an application resident on the client device.

16. The method of claim 14, wherein identifying the client device further comprises:
accessing client device location information; and
determining if the client device is within the targeted geographic area defined by the location data in the emergency announcement.

17. The method of claim 16, wherein the client device location information comprises longitude and latitude coordinates, and wherein the location data in the emergency announcement comprises longitude and latitude coordinates defining the targeted geographic area.

18. The method of claim 16, wherein the client device location information is stored remotely from the client device and wherein the determination if the client device is within the geographic area is performed by a remote server.

19. The method of claim 14, wherein identifying the client device further comprises:
initiating a location application on the client device; and
determining the location of the client device using at least one of network-based location information, client-based location information and hybrid location information.

20. The method of claim 19, wherein client location data is transmitted to a remote server and wherein the location determination is performed at the remote server.

21. The method of claim 19, wherein the client device determines the targeted geographic area defined by the location data in the emergency announcement and determines if the client device is within the geographic area.

22. The method of claim 14, further comprising:
activating a notification device, wherein the notification device comprises at least one of an indicator light, a ringer, a buzzer, an audible signal and a vibrator.

23. The method of claim 14, further comprising:
storing the emergency announcement at the client device.

24. The method of claim 23, further comprising:
automatically deleting the stored emergency announcement based upon at least one of the location of the client device, a predetermined time, and an event-based announcement delete request.

25. The method of claim 14, further comprising:
preventing the deletion of the emergency announcement at an initial display of the emergency announcement.

26. The method of claim 25, further comprising:
providing a direct feedback mechanism for response to the emergency announcement.

27. The method of claim 26, wherein the response to the emergency announcement is at least one of contacting a sender of the emergency announcement, sending an acknowledgement including the client device location, and acquiring additional information regarding the emergency announcement.

28. The method of claim 14, wherein identifying the client device further comprises:
identifying at least one base station capable of communicating to devices within the targeted geographic area; and
identifying the client device in communication with the at least one base station.

29. A wireless client device, comprising:
a transceiver;
a user interface; and
a carrier announcement manager (CAM) configured to receive an emergency announcement containing location data, configured to determine if the client device is within a targeted geographic area defined by the location data contained in the emergency announcement, and configured to activate a notification device on the user interface upon receipt of the emergency announcement, if the client device is within the targeted geographic area.

30. The client device of claim 29, wherein the client device is at least one of a wireless computing device, a wireless telephone, a cellular telephone, a personal digital assistant (PDAs), and a paging device.

31. The client device of claim 29, wherein the CAM is further configured to store the emergency announcement of the client device and to automatically delete the emergency announcement based on at least one of a location of the client device being outside the targeted geographic area, a specified time and an event-based trigger.

32. The client device of claim 29, wherein geographic location is determined using at least one of network-based location information, client-based location information and hybrid location information.

33. The client device of claim 29, wherein the CAM is configured to discard the emergency announcement if the client device is not within the targeted geographic area.

34. The client device of claim 29, wherein the notification device comprises at least one of a text-based display, a graphic-based display, an icon on a display, an indicator light, an audible signal, and a vibration.

35. The client device of claim 29, wherein the CAM is further configured to transmit a geographic position of the client device to a remote server on at least one of a periodic basis, an activation of the client device and an initiation of the CAM.

36. A computer-readable medium on which is stored a computer program for wirelessly communicating location-based emergency announcements, the computer program comprising instructions which, upon being executed by at least one computing device, causes the computing device to perform the process of:
receiving an emergency announcement containing location data that defines a geographic area;
determining a geographic position of the client device;
determining if the client device is within the geographic area defined by the location data in the emergency announcement; and
displaying the emergency announcement on the client device upon a determination that the geographic position of the client device is within the geographic area.

37. The computer-readable medium of claim 36, wherein the process of identifying the client device further comprises:
storing the emergency announcement at the client device; and
automatically deleting the stored emergency announcement based upon at least one of a current location of the client device, a current time, and an event-based announcement delete request.

38. A server for wirelessly communicating emergency announcements comprising:
means for generating an emergency announcement containing location data that defines a geographic area;
means for identifying a client device to receive the emergency announcement based on the geographic area and a geographic location of the client device; and
means for transmitting the emergency announcement to the client device.

39. The server of claim 38, wherein the means for identifying the client device further comprises:
means for accessing client device location information; and
means for determining if the client device is within the geographic area defined by the location data in the emergency announcement.

40. The server of claim 39, wherein the client device location information is stored remotely from the client device and wherein the means for determining if the client device is within the geographic area is a communication link to a remote server that determines that determines if the client device is within the geographic area.

41. The server of claim 38, wherein the means for identifying the client device further comprises:
means for initiating a location application on the client device; and
means for receiving client device location data.

42. The server of claim 41, wherein the means for identifying the client device further comprises:
means to determine the geographic location of the client device; and
means to compare the geographic location of the client device to the geographic area defined in the emergency announcement.

43. A client device for wirelessly receiving emergency announcements comprising:
means for receiving an emergency announcement containing location data that defines a geographic area; and
means for displaying the emergency announcement on the client device upon a determination that a geographic position of the client device is within the geographic area.

44. The client device of claim 43, further comprising:
means for accessing client device location information; and
means for determining if the client device is within the geographic area defined by the location data in the emergency announcement.

45. The client device of claim 44, further comprising:
means for storing the emergency announcement at the client device; and
means for automatically deleting the stored emergency announcement based upon at least one of a current location of the client device being outside the geographic area, a predetermined time, and an event-based announcement delete request.
